(19) United States
(12) Patent Application Publication
(10) Pub. No.: US 2014/0197933 A1
(43) Pub. Date: Jul. 17, 2014

(54) MULTI-DIRECTIONAL VIBRATING MOVING DEVICE

(71) Applicant: Yun Chien Cheng, Taipei (TW)

(72) Inventor: Yun Chien Cheng, Taipei (TW)

(21) Appl. No.: 13/740,275

(22) Filed: Jan. 14, 2013

(51) Int. Cl. G08C 19/16

(52) U.S. Cl. CPC G08C 19/16
USPC 340/12.5

(57) ABSTRACT

A moving device that moves in accordance with a control signal can comprise a plurality of device legs, a communication module to receive the control signal, and a control module to control a motor module in accordance with the control signal. The motor module can comprise several pager motors, whose supplied power can be individually adjusted by the control module in accordance with the control signal. The control signal is transmitted through Bluetooth from a user device that allows a user to input the desired direction and speed, or the desired mode of operation. In addition, the moving device may operate in various modes, such as the cycle mode, the random mode, and the free mode.

### BACKGROUND

1. Field of the Invention

The present invention relates generally to a multi-directional moving device and, more particularly, to a multi-directional vibrating moving device that can move in accordance with to a control signal sent wirelessly from a user device.

2. Description of the Related Art

FIG. 1A is a side view of the prior art moving device 100. As illustrated, the moving device 100 comprises the body shell 1, the support board 2, and the device legs 3. FIG. 1B is a sectional view of the prior art moving device 100 placing on top of the surface 6. As illustrated, the support board 2 is placed on top of the device legs 3, and is used to support the pager motor 4, the battery 5, and the body shell 1. The battery 5 is used to supply electricity to the pager motor 4. When the pager motor 4 vibrates, the vibration will cause the moving device 100 to move toward the direction 7.

For traditional vibrating moving device as illustrated in FIGS. 1A-1B, a user must first manually turn on the power switch to initiate the device's vibration. Once vibrating, the moving device can now move, but only in one direction. To stop the movement, the user must retrieve the moving device and manually turn off the power switch. However, such traditional vibrating moving device does not allow the user to exercise the full control over the moving device. For example, when the device is moving, a user cannot change its speed and direction. In addition, a user cannot start or end the movement without retrieving the device. Therefore, there is a need in the art to provide a multi-directional vibrating moving device that can be wirelessly controlled by a user.

### SUMMARY

An object of the present invention is to provide a multi-directional vibrating moving device that can be wirelessly controlled by a user.

According to some embodiments of the present invention, a moving device that moves in accordance with a control signal can comprise a plurality of device legs, a communication module to receive the control signal, and a control module to control a motor module in accordance with the control signal. The motor module can comprise several pager motors, whose supplied power can be individually adjusted by the control module in accordance with the control signal.

According to some embodiments of the present invention, the control signal is transmitted through Bluetooth from a user device that allows a user to input the desired direction and speed, or the desired mode of operation. In addition, the moving device may operate in various modes, such as the cycle mode, the random mode, and the free mode.

According to some embodiments of the present invention, a moving device can be controlled by, first, providing a graphical user interface to allow a user to select a desired direction and speed. Then, the information related to the direction and the speed is wirelessly transmitted to the communication module of a moving device. Thereafter, in accordance with the transmitted information, the control module of the moving device can individually control the pager motors.

### BRIEF DESCRIPTION OF THE DRAWINGS

The described embodiments of the present invention will be apparent through examination of the following detailed description in conjunction with the accompanying drawings, in which:

FIG. 1A is a side view of the prior art moving device.

FIG. 1B is a sectional view of the prior art moving device.

FIG. 2A is a simplified top view of the multi-directional moving device according to an embodiment of the present invention.

FIG. 2B is a simplified bottom view of the multi-directional moving device according to an embodiment of the present invention.

FIG. 3 is a simplified sectional view of the multi-directional moving device placing on top of a surface according to an embodiment of the present invention.

FIG. 4 is a simplified top view of the multi-directional moving device with possible moving directions according to an embodiment of the present invention.

FIGS. 5A-5B illustrate the GUI of a device that is used to control the multi-directional moving device according to some embodiments of the present invention.

FIG. 6 is graph illustrating the location of the control disk according to an embodiment of the present invention.

FIG. 7 is a system chart illustrating a system for controlling the motor module according to an embodiment of the present invention.

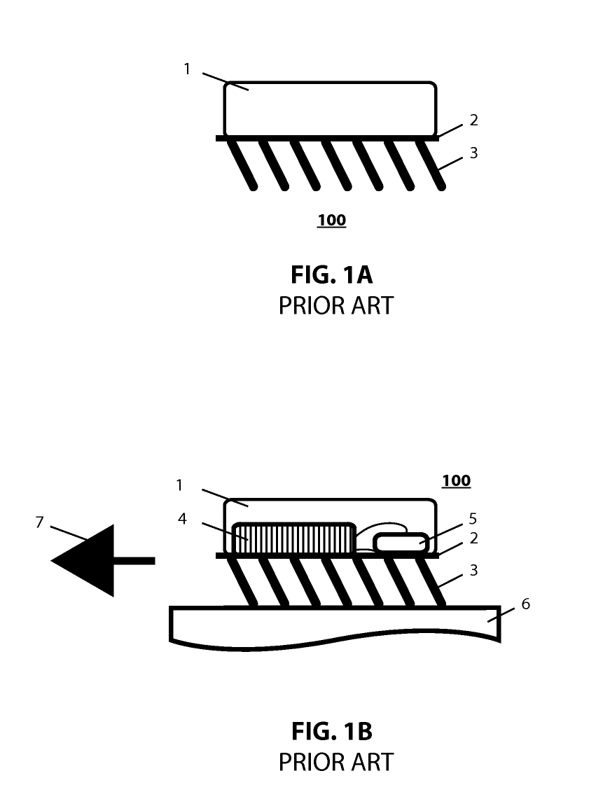

### DETAILED DESCRIPTION

To be consistent throughout the description and for clear understanding of the present invention, the following definition is hereby provided:

The term “pager motor” refers to a device adapted to cause vibration, such as a vibrating motor. For example, it can be an AC (alternating current) or DC (direct current) electric motor mounted with off-center weight.

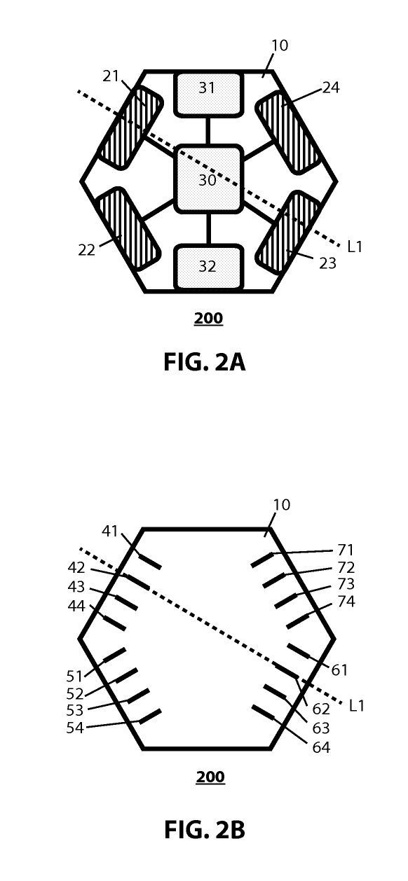

FIG. 2A is a simplified top view of the multi-directional moving device 200 according to an embodiment of the present invention. As illustrated, the multi-directional moving device 200 may comprise a power module 32 that may directly or indirectly supply power to the pager motors 21, 22, 23 and 24, the control module 30 and the communication module 31. The power module 32 may use a single-use battery, or may adopt a rechargeable battery system.

The communication module 31 may be used to receive the control signal from a user device through Bluetooth. The control signal may include information related to the power-on, power-off, moving direction, moving speed, and operating mode. The communication module 31 may also transmit the status signal to the user device. The status signal may include information related to the battery status and the current mode of operation. A person of ordinary skill in the art would recognize that the present invention is not limited by the kind of wireless technology incorporated, and the communication module 31 may incorporate other types of wireless technology, such as Radio Frequency (RF), infrared, Wi-Fi and Wireless LAN.

The control module 30 may be used to process the control signal received by the communication module 31, and to control the pager motors 21, 22, 23 and 24 in accordance with the control signal. The control module 30 may individually control each of the pager motors 21, 22, 23 and 24. For example, the control module 30 may turn on or turn off the pager motor 24. The control module 30 may also adjust the vibrating power of the pager motor 24 through pulse-width modulation (PWM) or by reducing the supplied DC voltage. For example, the power of the pager motor 24 may be reduced in half by adopting a 50% PWM duty cycle. Because the vibrating power correlates to the movement speed, the speed of the movement can be adjusted accordingly.

Although the multi-directional moving device 200 in FIG. 2A incorporates four pager motors and has a hexagon-shaped support board 10, the scope of the present invention is not so limited. Instead, a person of ordinary skill in the art would recognize that the multi-directional moving device 200 may have two, three, four or even more pager motors. Similarly, the support board may have a shape of a circle, a square, a polygon, or an irregular shape.

FIG. 2B is a simplified bottom view of the multi-directional moving device 200 according to an embodiment of the present invention. As shown, device legs 41-44, 51-54, 61-64, and 71-74 may be attached to the support board 10. A person of ordinary skill in the art would recognize that the device legs of the multi-directional moving device 200 may have other configuration.

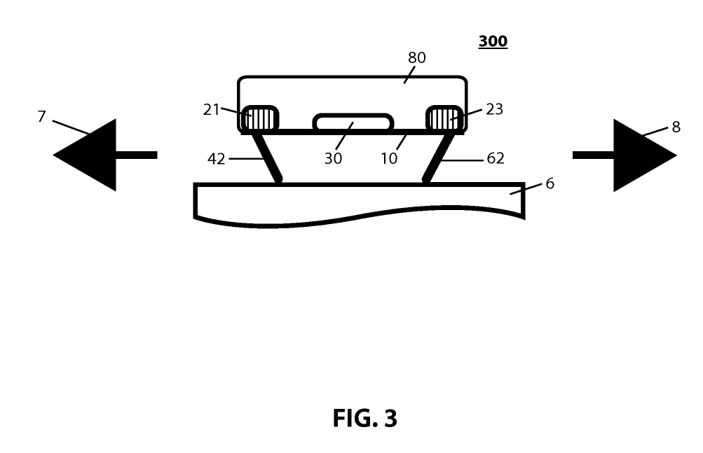

FIG. 3 is a simplified sectional view of the multi-directional moving device 300 along line L1 in FIGS. 2A and 2B. As shown, the multi-directional moving device 300 has a support board 10 that supports the control module 30, the pager motors 21 and 23, and the body shell 80. The body shell 80 may have a shape to accommodate the desired usage of the multi-directional moving device 300. For example, it may take the shape of a mouse, a cockroach, a spider, an insect, an animal, a cartoon character, a robot, a logo, or a pattern.

The device legs 42 and 62 are placed on top of the surface 6 and supports the support board 10. The device legs 42 and 62 may have the inward-bending configuration to facilitate the movement of the multi-directional moving device 300. For example, when the pager motor 21 is turned on and the pager motor 23 is turned off, the multi-directional moving device 300 may move toward the direction 7. Similarly, when the pager motor 21 is turned off and the pager motor 23 is turned on, the multi-directional moving device 300 may move toward the direction 8. A person of ordinary skill in the art would recognize that the device legs of the present invention may also adopt other kinds of configuration.

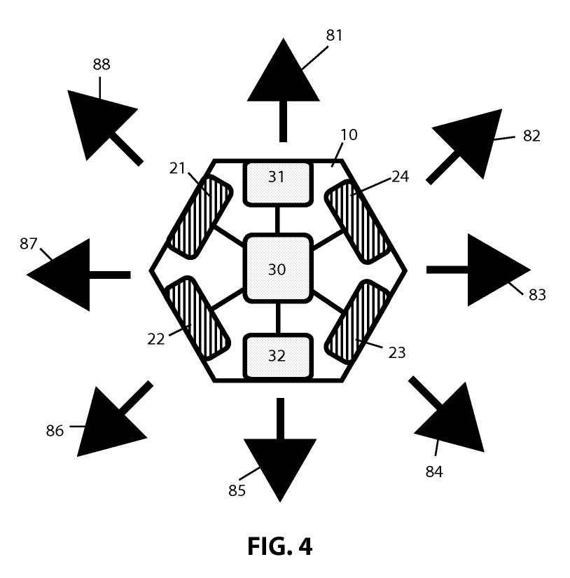

FIG. 4 is a simplified top view of the multi-directional moving device according to an embodiment of the present invention. As previously discussed, the multi-directional moving device may comprise the support board 10, the pager motors 21-24, the control module 30, the communication module 31, and the power module 32.

The multi-directional moving device may be operated in several modes. For example, in a “forward moving mode”, the multi-directional moving device moves in a given direction. For example, to move in the direction 81, the pager motors 21 and 24 may be turned on. Similarly, to move in the direction 82, the pager motor 24 may be turned on. To move in the direction 83, the pager motors 23 and 24 may be turned on. To move in the direction 84, the pager motor 23 may be turned on. To move in the direction 85, the pager motors 22 and 23 may be turned on. To move in the direction 86, the pager motor 22 may be turned on. To move in the direction 87, the pager motors 21 and 22 may be turned on. To move in the direction 88, the pager motor 21 may be turned on. According to an embodiment of the present invention, in a forward moving mode, the multi-directional moving device may continue to move in the given direction unless the direction or the mode of operation is changed by the user.

In a “vibrating mode”, all pager motors may be turned on, and the multi-directional moving device may be vibrating without moving to a particular direction.

In a “cycle mode”, the multi-directional moving device may start its movement in a staring position, may then move following a cycle shape, and may come back to the starting position after completing a cycle. Once a cycle is completed, the multi-directional moving device may repeat the cycle until user interruption. The cycle shape may be a circular shape, a polygonal shape, an irregular shape, or a shape according to a user's input.

To substantially move in a circular shape at time 0, for example, the pager motor 21 may be turned on. At time T, the pager motors 21 and 22 may be turned on. At time 2T, the pager motor 22 may be turned on. At time 3T, the pager motors 22 and 23 may be turned on. At time 4T, the pager motor 23 may be turned on. At time 5T, the pager motors 23 and 24 may be turned on. At time 6T, the pager motor 24 may be turned on. At time 7T, the pager motors 21 and 24 may be turned on, thereby completing a cycle.

Similarly, to substantially move in a rectangular shape, at time 0, the pager motor 21 may be turned on. At time T, the pager motor 22 may be turned on. At time 2T, the pager motor 23 may be turned on. At time 3T, the pager motor 24 may be turned on, thereby completing the cycle. A person of ordinary skill in the art would recognize that, similar to the circular shape, the size of the rectangular shape may be enlarged by adapting a longer T setting.

In addition, a user may input the desired cycle shape by, for example, drawing on the touchscreen of the user device, and indicating that the drawing is to be used in the cycle mode. If the starting position of the cycle shape does not substantially match the ending position, the GUI may display a warning, may automatically joining the starting and ending positions, or may simply start the next cycle at the ending position.

A person of ordinary skill in the art would recognize that the actual movement of the multi-directional moving device depends on many factors, such as the surrounding environment, the surface property, the device's device legs, and the pager motors. Therefore, even operating in a cycle mode, the starting position and the ending position in a cycle may differ.

In a “random mode”, the on/off statuses of the pagers motors 21-24 may be at random. For example, the multi-directional moving device may move in accordance with a continuous or discrete random walk model.

In an “adapted mode”, the multi-directional moving device may move in accordance with a source signal. For example, under this mode, a user may select the a song to play on a user device, and the multi-directional moving device may move in accordance with the tempo or volume of the selected music. Moreover, when the source signal is a human sound, then the multi-directional moving device may move in accordance with a user's vocal command. For example, when the user says “left”, the multi-directional moving device may adopt the left direction.

In a “free mode”, the multi-directional moving device may move in accordance with a locus input by a user. A user may input the locus by drawing on the touchscreen of the user device, or may recall a locus previously saved.

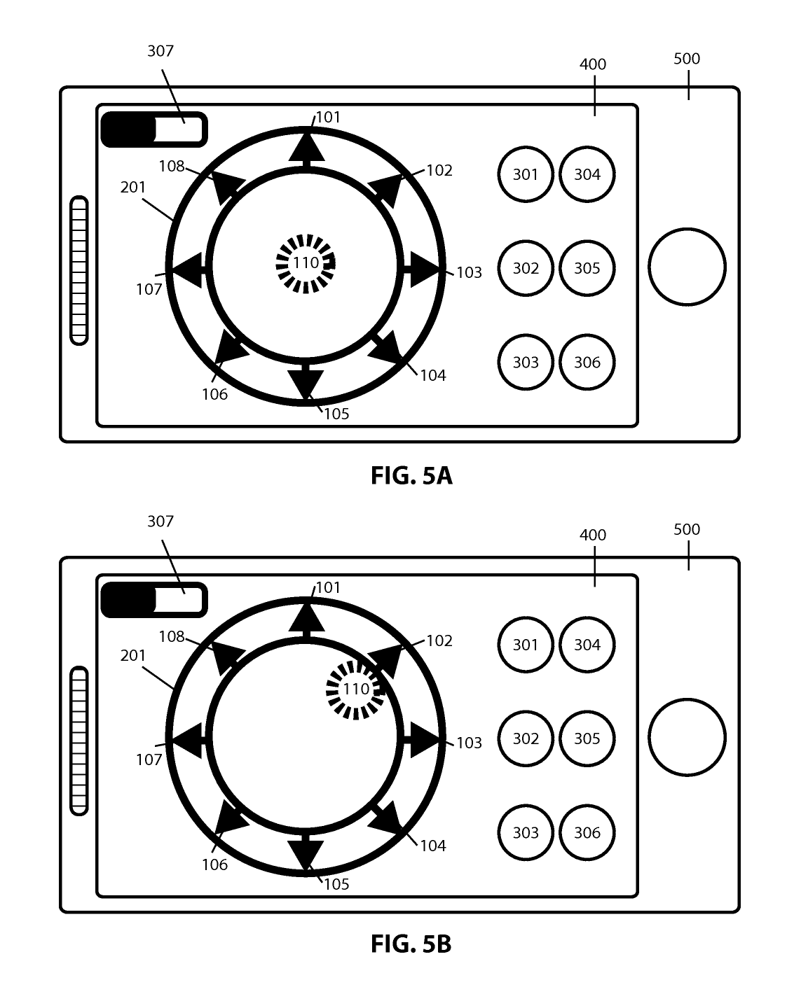

FIGS. 5A-5B illustrate the graphical user interface (GUI) 400 of a user device 500 that is used to control the multi-directional moving device according to some embodiments of the present invention. The user device 500 may be a mobile device, a mobile phone, a computer, a tablet computer, a gaming machine, or a specialized device. The GUI 400 may adopt a touchscreen that can detect the presence and location of a touch within the display area. The GUI 400 may comprise an on-off switch 307 that allows the user to remotely turn on or turn off the multi-directional moving device. The GUI 400 may also comprise the bottoms 301-306, each of which may correspond to a particular mode of operation. For example, the bottom 301 may correspond to the “random mode”, and the bottom 302 may correspond to the “cycle mode”.

In addition, the GUI 400 may comprise a control wheel 201 with direction labels 101-108. In a “forward moving mode”, a use may move the multi-directional moving device toward a direction by moving the control disk 110 toward the direction. For example, in FIG. 5A, because the control disk 110 is at the center default position, the multi-directional moving device may be stationary, or may enter into a “vibrating mode”. In FIG. 5B, the control disk 110 is moved toward the direction label 102. The direction label 102 may correspond to the direction 82 in FIG. 4. Accordingly, the control module may turn on the pager motor 24 in FIG. 4 to allow the multi-directional moving device to move in the desired direction.

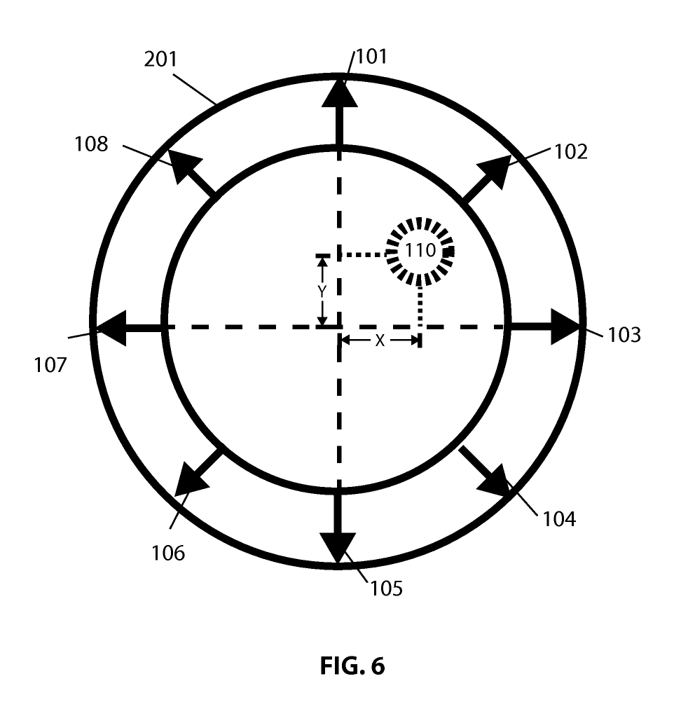

Moreover, as illustrated in FIG. 6, the location of the control disk 110 inside the control wheel 201 with direction labels 101-108 may be used to set the desired speed and direction of the movement. By extracting the coordinates X and Y of the control disk 110 inside the control wheel 201, the user device may decide which pager motors to be turned on and what PWM duty cycles to be used. For example, when the control disk 110 is halfway toward the direction label 102, then the pager motor 24 may be turned on at a 50% PWM duty cycle.

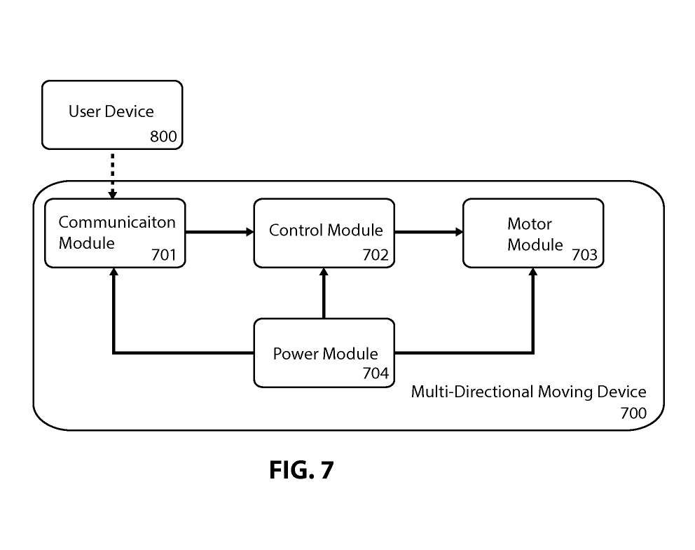

FIG. 7 is a system chart illustrating a system for controlling the motor module 703 according to an embodiment of the present invention. At the user interface of the user device 800, the user may input the desired mode of operation, and the desired direction and speed of the multi-directional moving device 700 if needed. The user's input may then be converted by the user device 800 to a control signal, which may be wirelessly transmitted to the communication module 701 of the multi-directional moving device 700. Thereafter, the control signal may be passed to the control module 702, which may control the motor module 703 accordingly. The motor module 703 may incorporate several pager motors. In addition, the power module 704 may supply power to the communication module 701, the control module 702, and the motor module 703.

What is claimed is:

1. A moving device for moving in accordance with a control signal, comprising:
a plurality of device legs;
a communication module to receive the control signal; and
a control module to control a motor module according to the control signal,
wherein the motor module comprises a first pager motor and a second pager motor.

2. The moving device of claim 1, wherein the control signal comprises direction information, and the control module adjusts the first pager motor and the second pager motor in accordance with the direction information.

3. The moving device of claim 2, wherein the control signal further comprises speed information, and the control module uses a pulse-width modulation method to adjust the first pager motor and the second pager motor in accordance with the speed information.

4. The moving device of claim 3, wherein the control signal further comprises operation mode information to direct the moving device to operate in a selected mode.

5. The moving device of claim 4, wherein the selected mode is a cycle mode, and the moving device moves in a circular shape.

6. The moving device of claim 4, wherein the selected mode is a cycle mode, and the moving device moves in a user-selected shape.

7. The moving device of claim 3, wherein the selected mode is a random mode, and the moving device moves randomly.

8. The moving device of claim 3, wherein the selected mode is an adapted mode, and the moving device moves in accordance with a source signal.

9. The moving device of claim 8, wherein the source signal is a user-selected song signal, and the moving device moves in accordance with the tempo of the user-selected song signal.

10. The moving device of claim 8, wherein the source signal is a user-selected song signal, and the moving device moves in accordance with the volume of the user-selected song signal.

11. The moving device of claim 3, wherein the selected mode is a free mode, and the moving device moves in accordance with a locus input by a user through a touchscreen display.

12. The moving device of claim 3, wherein the communication module receives the control signal through Bluetooth.

13. The moving device of claim 3, wherein the communication module receives the control signal from a user device that comprises a graphical user interface.

14. The moving device of claim 13, wherein the graphical user interface comprises a control wheel that allows the user to provide a desired moving direction and a desired moving speed.

15. The moving device of claim 14, wherein the graphical user interface further comprises at least three mode bottoms.

16. The moving device of claim 15, wherein the plurality of device legs have an inward-bending configuration.

17. The moving device of claim 16, wherein the pager module further comprises a third pager motor and a fourth pager motor.

18. The moving device of claim 17 further comprising an insect-shaped body shell.

19. A method to control a moving device, comprising:
providing a graphical user interface to allow a user to select a desired direction and a desired speed;
transmitting information related to the desired direction and the desired speed wirelessly to a moving device; and
controlling a motor module in the moving device according to the information,
wherein the motor module comprises a first pager motor and a second pager motor.

20. The method of claim 19, wherein said controlling comprises using a pulse-width modulation method.
